(19) United States
(12) Patent Application Publication
(10) Pub. No.: US 2013/0085056 A1
(43) Pub. Date: Apr. 4, 2013

(54) QUARTZ GLASS BODY AND A METHOD AND GEL BODY FOR PRODUCING A QUARTZ GLASS BODY

(71) Applicant: QSIL GmbH Quarzschmelze Ilmenau, Langewiesen (DE)

(72) Inventor: Thomas KREUZBERGER, Ilmenau (DE)

(73) Assignee: QSIL GMBH QUARZSCHMELZE ILMENAU, Langewiesen (DE)

(21) Appl. No.: 13/687,337

(22) Filed: Nov. 28, 2012

Related U.S. Application Data
(63) Continuation of application No. PCT/EP2011/057773, filed on May 13, 2011.

(30) Foreign Application Priority Data
Jun. 2, 2010 (DE) DE102010022534.7

(51) Int. Cl. C03B 20/00; C03C 3/00; C03C 1/00

(52) U.S. Cl. CPC C03B 20/00; C03C 1/006; C03C 3/00
USPC 501/12; 65/17.2; 501/39

(57) ABSTRACT

A method for producing a quartz glass body from a get body is provided, wherein the gel body generated from a colloidal suspension is at least formed and compressed into the quartz glass body Displacement bodies are added to the colloidal suspension prior to gelating into the gel body, and are completely removed from the gel body after gelating, wherein hollow spaces are generated at the positions of the removed displacement bodies, so that a translucent or opaque quartz glass body is generated. Further, a gel body for producing a quartz glass body is provided, wherein displacement bodies are introduced into the gel body that can be completely removed from the gel body, so that hollow spaces arise at the positions of the displacement bodies. A quartz glass body is also provided that includes vacuoles or hollow spaces filled with gas.

This nonprovisional application is a continuation of International Application No. PCT/EP2011/057773, which was filed on May 13, 2011, and which claims priority to German Patent Application No. DE 10 2010 022 534.7, which was filed in Germany on Jun. 2, 2010, and which are both herein incorporated by reference.

### BACKGROUND OF THE INVENTION

1. Field of the Invention

The invention relates to a method for the production of a quartz glass body from a gel body, whereby the gel body generated from a sol is at least formed and compressed into the quartz glass body. The invention relates further to a gel body for the production of a quartz glass body and to a quartz glass body.

2. Description of the Background Art

Translucent and opaque quartz glasses, which in contrast to clear and transparent quartz glass have microscopically small gas inclusions in high concentrations, are known from the conventional art. The gas inclusions cause light scattering and thus give the glass a white appearance.

Translucency is understood to be the partial light transmission of a body, whereby quartz glass, also called silica glass, is described as translucent when light striking the glass is poorly absorbed in the material despite scattering.

Opacity is understood to be the reciprocal property of translucency. In other words, if a substance has a high translucency, it thus has a low opacity and vice versa. In this regard, opacity represents a measure for the nontransmission of light by a body.

The material properties of opaque or translucent quartz glasses vary over a broad range depending on the manufacturing process, because they are determined both by the particular base glass and also by the gas inclusions finely distributed therein.

In this case, properties such as spectral absorption, viscosity, and chemical purity of the quartz glass are determined by a selection of the base glass.

Material properties such as density, light scattering, i.e., the so-called scattering indicatrix, and the thermal insulation effect are determined by the gas inclusions. The behavior of the material as well is influenced during the thermal shaping and welding with clear quartz glass.

The gas inclusions in the material are characterized by parameters, whereby the parameters comprise a size distribution, a number of the gas inclusions per volume element, a typical form, such as round bubbles or tubes, and a spatial distribution, i.e., homogeneity. Other parameters are orientation or isotropy, gas composition, gas pressure, and a relationship between an open and closed porosity.

Numerous methods are known for the production of opaque quartz glass, whereby the base glass is produced from silicon dioxide. Quartz crystal granules of natural or synthetic origin, quartz glass granules of natural or synthetic raw materials, slips of quartz glass granules and nanoscale silicic acid, such as pyrogenic silicic acid, and combinations of these silicon dioxide sources are used as sources for the silicon dioxide.

The gas inclusions in the silicon dioxide grains themselves, gases of the melting atmosphere, and/or special additives to the melt, which generate the gas during a melting process of the silicon dioxide, whereby such an additive is silicon nitride or silicon carbide powder, function as sources for the gas for the gas inclusions.

The gas sources themselves and/or grain interspaces of the melting granules act as the seed crystal for a formation of the gas inclusions.

It is known further that for the production of opaque quartz glasses from coarse silicon dioxide grains with approximately 100 μm, high temperatures are necessary to reach at least the so-called softening point or softening temperature of the silicon dioxide. Such glasses have densities in the range from 1.9 to 2.1 g/cm³ and contain relatively large bubbles of about 20 μm to 200 μm in concentrations of about 0.3 million bubbles per cm³ to 1 million bubbles per cm³.

Opaque quartz glasses with much smaller bubbles are produced with the use of fine silicon dioxide grains. Fine silicon dioxide grains require much lower compression temperatures during their processing.

Furthermore, slip processes for the production of quartz glasses are known from the conventional art.

Such a method is described in DE 44 40 104 A1, which corresponds to U.S. Pat. No. 5,736,206. In this method, a molded body of quartz glass having at least one surface region of transparent quartz glass is produced. In this case, a base body is produced by the slip casting process, whereby quartz glass having a purity of at least 99.9% is ground up to a powder with a particle size of less than 70 μm. A slip is made from the powder and stabilized during a time period of 1 hour to 240 hours by being kept in continuous motion, whereby the stabilized slip is filled into a porous form corresponding to the base body and left therein for a predetermined time. After removal of the form, the obtained base body blank is dried and then sintered in a furnace. During a time period of at least 40 minutes, the base body blank is exposed to a temperature of over 1300° C. and the sintered base body is cooled. A surface region of the opaque, porous, gas-impermeable base material, forming the base body, is then heated locally up to the transformation of the porous, opaque base material into transparent quartz glass, until the thickness of the transparent surface region is at least 0.5 mm, and its direct spectral transmission has a value of at least 60% for a layer thickness of 1 mm in the wavelength range of λ=600 nm to λ=650 nm. A molded body of quartz glass is described further.

Further, DE 102 43 953 A1 discloses a method for the production of a part made from opaque quartz glass. In the method, a suspension of silicon dioxide grains and a liquid is prepared first. A prepared suspension is then homogenized and poured into a form. Further, the suspension is dried with the formation of a porous green body, whereby the green body is then sintered to form the quartz glass part. In so doing, at least one portion of the grains comprises porous granule particles, produced from agglomerates of nanoscale, amorphous, synthetically produced silicon dioxide primary particles with an average primary particle size of less than 100 nm, whereby the particle size of the granules is less than 1 mm.

The so-called sol-gel method for producing simple and clear, i.e., transparent optical lenses is also known from the state of the art. The sol-gel method is substantially characterized in that in a first process step for producing a quartz glass body or silica glass body the so-called sol is produced and then in a second process step filled into a suitable form in a pouring process and gelled there. Thereafter, in a third process step a stabilization of the gel body occurs, before first an unmolding, then a drying, a purification of the gel body by way of oxidizing gases, and a sintering and compression to a clear silica glass body take place in further process steps.

When the sol-gel method is used, an organosilicon liquid or a silicon dioxide dispersion or combinations of these are gelled to form an open-pored gel whose skeletal structure includes silicon dioxide.

The sol is preferably poured into a form before the gelling, so that a so-called wet gel body forms. An open-pored dry gel body is produced from the wet gel body by a suitable drying method; the subsequent heating of the dry gel body to temperatures of up to 1500° C. leads to a compression of the body due to the collapse of pores. The result of the heating is a clear quartz glass body, which has predetermined dimensions. The specification of the dimensions occurs on the basis of the casting form with consideration of the shrinkage of the wet gel body.

JP 5070175 A discloses a method for the production of porous glasses from a gel body, which is formed from a sol. The gel body is formed into the porous glass and compressed and the displacement bodies present in the gel body are burned, so that hollow spaces form in the glass at the positions of the displacement bodies.

JP 1079028 A describes a method for the production of glass, whereby for the production of the glass a material found within the pores of a porous starting material is burned.

### SUMMARY OF THE INVENTION

It is therefore an object of the invention to provide a method for the production of a quartz glass body improved compared with the prior art, an improved gel body for the production of a quartz glass body, and an improved quartz glass body.

In an embodiment of the method for the production of a quartz glass body from a gel body, the gel body generated from a sol can be at least formed and compressed into the quartz glass body.

In so doing, displacement bodies are added to the sol before the gelling to form the gel body and after the gelling these are removed completely from the gel body, whereby hollow spaces are generated at the positions of the removed displacement bodies.

According to an embodiment of the invention, a translucent or opaque quartz glass body is generated, whereby after the removal of the displacement bodies the gel body can be compressed in such a way that pores within the gel body collapse and a dense and clear glass forms between the hollow spaces.

In the production of the opaquely or translucently formed quartz glass body according to an embodiment of the invention, which is based on the so-called sol-gel method, even in the gelling process step, the hollow spaces of the desired opaque quartz glass are generated in the silicon dioxide skeleton, whereby the displacement bodies represent temporary placeholders for the hollow spaces. The displacement bodies behave inertly in the sol-gel process and are removed in further steps after the stabilization of the silicon dioxide skeleton.

Thus, it is possible to produce pure and opaque quartz glass bodies with a defined geometry and a defined structure of the hollow spaces. Because of the use of displacement bodies to generate the hollow spaces, an amount and distribution of the arising hollow spaces can be predetermined, which results in the advantage that the material properties of the quartz glass body, particularly the scattering properties thereof, can be predetermined very precisely.

A formation of the hollow spaces is also decoupled in an advantageous manner from the formation of the quartz glass, which results in the possibility of producing various quartz glasses with the most different geometries. The result of the homogeneous compression of the gel body after the gelling thereof is furthermore that the risk of the occurrence of so-called blowholes, in other words, undesirable hollow spaces within the quartz glass body, is prevented.

In addition, mechanical finishing processes on the generated quartz glass body are eliminated in an especially advantageous manner or are at least reduced, with the result of a simplification of the production of the quartz glass body and consequently a reduction of production costs.

According to an embodiment of the method, it is possible to generate hollow spaces having a size of 0.5 μm to 30 μm. The size of the hollow spaces can be specified thereby very precisely, because the shrinking of the gel body to generate the quartz glass body is known. The size of the introduced displacement bodies is selected depending on the desired size of the hollow spaces in the quartz glass body and the known shrinking of the hollow spaces.

The displacement bodies can be distributed homogeneously within the sol, so that a homogeneous distribution of the hollow spaces in the quartz glass body and thereby a uniform scattering are achieved.

Further, a form of the hollow spaces is predetermined by a form of the displacement bodies. The displacement bodies and consequently the hollow spaces in this case can have any possible form such as, for example, a spherical form, a cylindrical form, a conical shape, a polygonal form, or a mixture thereof. This results in further simplification of the specification of the optical properties of the quartz glass body.

In an embodiment of the method, after gelling of the sol to form the gel body and before the compression of the same to quartz glass, the displacement bodies are removed from the glass, whereby the removal occurs particularly through chemical reactions in which the displacement bodies are converted to gases. After the gelling of the sol to form the gel body, the displacement bodies are completely burned within the gel body, so that residues which negatively impact the desired optical properties are effectively prevented.

Furthermore, in an embodiment of the method of the invention, the hollow spaces can be filled with a gas before the compression of the gel body. The filling occurs in particular by permeation of the gas through the open-pored silicon dioxide structure. The gas can be any gas that remains stable during the production of the quartz glass body. The gas is, for example, helium, argon, xenon, water, hydrogen, nitrogen, oxygen, carbon monoxide, and carbon dioxide. The material properties of the quartz glass body can be predetermined on the basis of the employed gas. The behavior of the material in the case of thermal shaping and welding with other materials, particularly in the case of welding with clear quartz glasses, and the mechanical properties of the quartz glass body such as, for example, its viscosity, can be predetermined.

After the hollow spaces are filled with the gas, the gel body is compressed in that the temperature is increased so far that the pores within the gel body collapse, so that dense, clear glass forms between the hollow spaces and has the result that an opaque quartz glass body arises from the gel body. In this regard, each gas inclusion in the opaque quartz glass body can be traced back to a casting of the corresponding displacement body. Thus, the structure of the gas inclusions is clearly determined by the structure of the displacement bodies in the wet gel.

In an embodiment of the method of the invention, the hollow spaces are not filled with gas before the compression. After the removal, particularly the burning of the displacement bodies, the compression of the open-pored silicon dioxide structure of the gel body is carried out in vacuum, so that vacuoles form at the positions of the hollow spaces. For the production of opaque silica glass in this embodiment of the method in an advantageous manner no gas is necessary to generate a counter pressure in the bubbles. This advantage results from the fact that the compression of the dry gel in the sol-gel method can occur at low temperatures. At these temperatures, a collapse of mesopores results, which have a diameter of from 2 nm to 50 nm, but not a collapse or at least an extremely slow collapse of the much larger hollow spaces with diameters of several micrometers.

To make possible a simple generation and processing of the sol and the gel formed therefrom and thus a cost-effective production of the quartz glass body, the sol is formed preferably from a finely dispersed silicic acid, water, and tetraethyl orthosilicate. Further, a simple guaranteeing of the material properties, such as, e.g., the spectral light transmission, spectral light scattering, inclusions or bubbles, surface quality, such as, e.g., the microroughness and light scattering, and the geometric tolerances of the generated quartz glass body is possible due to the formation of the sol from these components.

In summary, it is possible by the method of the invention and embodiments thereof to produce a quartz glass body with a predetermined geometry, predetermined concentration, size, and distribution of the vacuoles or hollow spaces, and predetermined gas composition within the hollow spaces.

A gel body for the production of a quartz glass body is characterized in that displacement bodies are introduced into the gel body and these can be removed completely from the gel body in such a way that hollow spaces arise at the positions of the displacement bodies.

According to an embodiment of the invention, the gel body has pores, which collapse during a defined compression in such a way that a dense and clear glass forms between the hollow spaces.

In this case, the displacement bodies in an embodiment of the invention can be made of plastic, whereby the plastic can be, for example, polyethylene, polystyrene, and/or poly(methyl methacrylate). These plastics are formed, on the one hand, in such a way that a shrinking of the displacement bodies during the aging and drying of the gel is prevented. On the other hand, these plastics are characterized in that they are completely combustible in oxygen.

Further, the gel body can have a porous structure, which is formed in such a way that during burning of the displacement bodies within the gel body a gas exchange with the surroundings occurs. The porous structure also contributes to complete burning of the displacement bodies, because an unhindered gas exchange with the surroundings can occur.

A quartz glass body, produced in a method of the invention, has vacuoles or gas-filled hollow spaces. The hollow spaces have a defined size, are arranged in a defined structure, and a dense and clear glass is formed between the hollow spaces.

This quartz glass body is suitable based on its material properties and its optical properties particularly also for use as an optical element, for example, as a light diffuser in UV-light applications for the defined scattering of the UV light. Because quartz glass in contrast to conventional glasses and plastic glasses is resistant to UV light, apart from the certain scattering of UV light, a reduction of the maintenance cost for the devices is achieved as well, in which the quartz glass body is integrated as an optical element.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically a flowchart of a method of the invention for the production of a quartz glass body from a gel body, and

FIG. 2 shows schematically a sectional view of a section of a quartz glass body.

### DETAILED DESCRIPTION

Parts corresponding to one another are provided with the same reference characters in all figures.

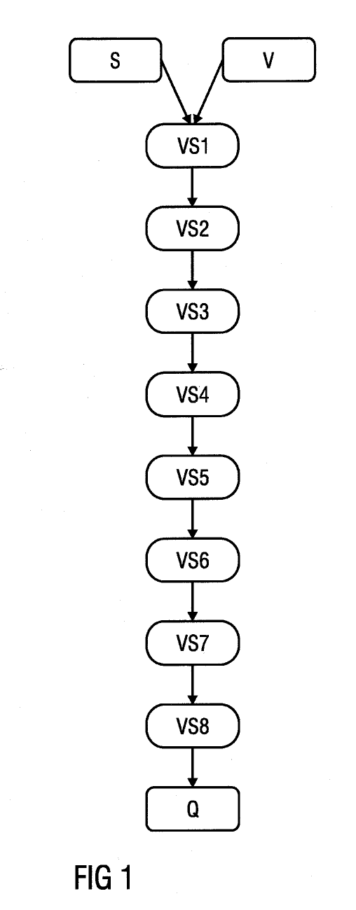

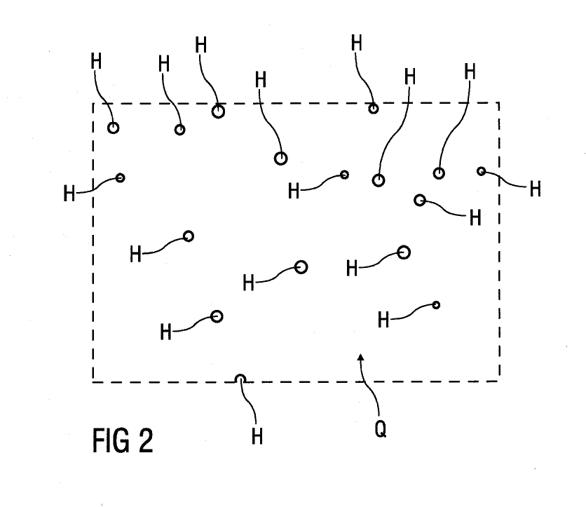

FIG. 1 shows a flowchart of a method of the invention for the production of an opaque or translucent quartz glass body Q, whereby the method is based on a sol-gel method for the production of quartz glass. To generate the opaque or translucent properties of the quartz glass body Q, the body has hollow spaces, which are filled with a gas and are shown in greater detail in FIG. 2.

All sol-gel methods, by which pure and clear, i.e., transparent quartz glasses can be produced, are suitable for the production of quartz glass body Q. Therefore, apart from the assurance of the material properties, such as, e.g., spectral light transmission, spectral light scattering, inclusions or bubbles, surface quality, such as, e.g., microroughness and light scattering, and the geometric tolerances of the quartz glass body Q to be generated, requirements from processes for the transformation of a gel body into the quartz glass body Q and economic aspects are also to be considered by the selection of the formulation of the sol S.

A suitable method is described in EP 0 131 057 A1 or DE 33 90 375 C2 (which both correspond to U.S. Pat. No. 4,681,615 and U.S. Pat. No. 4,801,318, and which are incorporated herein by reference), in which the sol S is produced from water, tetraethyl orthosilicate, also designated as TEOS below, and colloidal silicic acid. This method enables the production of very pure quartz glass with a high surface quality and low production expenditures.

In particular, the sol S for the production of the quartz glass body Q is produced according to the methods and compositions cited in EP 0 131 057 A1 or DE 33 90 375 C2. Gels with a high silicon dioxide concentration and relatively low shrinking can be produced with other formulations, which contain only colloidal silicic acid as the silicon dioxide source. In this regard, based on the gelling energetics rapid processing of the sol is necessary. Other formulations that contain exclusively alkoxysilanes, such as, e.g., TEOS, as the silicon dioxide source lead to wet gels with a high proportion of liquid, an especially fine-porous silicon dioxide skeleton, and a high inner surface.

To produce the translucency or opacity of the quartz glass body Q, in a first process step VS1 finely dispersed displacement bodies V are added to the sol S and combined with it. In so doing, the mixing occurs in the manner that a homogeneous distribution of the displacement bodies V in the sol S occurs.

The displacement bodies V are introduced into the sol S as liquid droplets or as solid particles. To generate the liquid droplets, a liquid which is not miscible with the sol S is added to the sol S as displacement bodies V in the sol S. This liquid is, for example, an oil. An emulsion is then formed from the sol S and the liquid, so that the liquid droplets are distributed in the sol S.

However, the use of solid particles is preferred because of their higher stability. A low density difference between the particles and the sol S must be created in such a way that separation does not occur during further processing of the mixture of the sol S and the displacement bodies V. The composition of the sol S is also selected in such a way that short gelling times are achieved. Thus, a separation is also prevented.

The sol S has a ratio of the molar starting amounts of water to TEOS to silicon dioxide in the range of “10 to 1 to 0” to “25 to 1 to 6.” Density values between 0.97 g/cm³ and 1.25 g/cm³ result at these ratios for the hydrolyzed and titrated sol S. To prevent the separation of the displacement bodies V and the sol S, particles are selected whose material densities are within this range.

To generate a high-quality quartz glass body Q with defined material properties and optical properties, it is necessary that the displacement bodies V are completely removed from the sol S after its gelling, i.e., from the arising gel body.

Because removal of the displacement bodies V in the dry gel stage is more cost-effective than removal in the wet gel stage, the displacement bodies V are burned in the dry gel stage. To enable complete burning, the displacement bodies V are made from high-purity plastics, which are completely combustible in oxygen. The employed plastics are polyethylene, polystyrene, or poly(methyl methacrylate), also called PMMA below, with densities of about 0.9 g/cm³, about 1.1 g/cm³, or about 1.2 g/cm³.

A selection of the displacement bodies V by size and size distribution is made depending on the specified requirements for the opaque product. If a very fine structure of the gas inclusions to be generated in the quartz glass body Q is to be generated, displacement bodies V with a small size are selected. In the case of coarser structures, larger displacement bodies V are used.

To generate, for example, a quartz glass with 10⁸ hollow spaces H per cm³, about 1.25 10¹⁰ particles as displacement bodies V, which at a size of 10 μm have a total weight of about 12.5 g, are added to the sol S with a volume of 1 liter and a silicon dioxide content of 275 g/L.

Microbeads or powders are used as particles. Polydisperse acrylic powder is used as the powder in an embodiment of the method.

The use of microbeads, compared with the use of powder, enables a simple quantitative calculation for achieving the desired properties of the opaque quartz glass body Q. The desired size of hollow spaces H to be generated can also be realized in an especially simple manner by way of the microbeads. Sizing methods are employed to narrow a desired particle size range hereby. Monodisperse PMMA beads are used as microbeads in an embodiment of the method.

To achieve the desired material properties and optical properties of the quartz glass body Q as precisely as possible, a sol S with an especially high chemical purity is used. To assure this high chemical purity of the sol S, displacement bodies V are purified before addition to the sol S.

The displacement bodies V are then mixed into the sol S in a defined amount and defined size distribution immediately before a casting process and homogeneously distributed in the sol. This addition occurs after the pH of the sol S has been adjusted to values between 4 and 5. The gelation process is started by the adjustment of the pH to these values.

In so doing, the displacement bodies V are introduced into the sol S in such a way that no unacceptably high shearing forces occur during the homogenization. Thus, a change in the size distribution of the displacement bodies is prevented.

To shorten the production process, the addition of the displacement bodies V to the sol S occurs in the form of a particle dispersion, so that a drying process of the displacement bodies V after their purification can be omitted.

In an alternative version for the introduction of the displacement bodies V into the sol S, which still has a pH of about 2, the pH adjustment of the sol S for initiating gelation occurs by means of the addition of the particle dispersion. To this end, the particle dispersion is combined with an ammonia solution and in same molar amount with acetic acid. Next, the particle dispersion is added to the untitrated sol S, so that the sol has a pH of approximately 5. It is achieved in this way that the time for separation in the motionless sol S can be kept very short. The amounts for the ammonia solution and acetic acid determine the gelling times and are determined experimentally. A guide value is that at a temperature of 20° C. and a desired gelling time of 30 minutes approximately 5 times the molar amount of the acid present in the sol S is added.

After the mixing of the sol S and the displacement bodies V, in a second process step VS2 the mixture is poured into a casting mold, which is not shown. The casting mold is designed so that its inner contour corresponds to a contour of the quartz glass body Q to be produced on an enlarged scale. The scale is selected in such a way that despite a shrinking of the sol S or of the formed gel body, a quartz glass body Q with the desired dimensions is made.

After gelling of the sol S to a wet gel body in the third process step VS3, the wet gel body is removed from the casting mold in a fourth step VS4 and dried in air to a so-called xerogel in a fifth process step VS5.

A susceptibility to crack formation in the xerogel, as occurs during drying of the wet gel body and results from the shrinking of the wet gel body, is not increased by the introduction of the displacement bodies V.

The volume of the displacement bodies V and their size remain constant during this compression phase of the silicon dioxide skeleton, i.e., from the addition to the sol S until the dry gel stage is reached.

After the drying, the displacement bodies V are removed from the xerogel in a sixth process step VS6. The removal of the displacement bodies V made of plastic occurs in a furnace under an oxygen atmosphere at temperatures between 300 and 500° C. The gas exchange in the xerogel in this case occurs because of its porous structure. To achieve complete elimination of combustion products, a sufficient oxygen supply is assured by the design of the furnace or active oxygen is added to the xerogel alternatively or in addition. In this case, an alternating evacuation and refilling of the furnace chamber with oxygen leads to an especially efficient combustion.

Thus, hollow spaces H, whose size and form correspond to the size and form of the removed displacement bodies V, form in the xerogel body at the positions of the displacement bodies V.

After the removal of the displacement bodies V from the xerogel body, the body is purified by means of chlorine-containing gas. In so doing, the temperature is selected in such a way that the open pores of the xerogel body do not collapse. In an alternative embodiment, there is no purification of the xerogel body.

Next, in a seventh process step VS7, the hollow spaces H within the xerogel body are filled with a gas in that the furnace chamber is first evacuated and then filled with the desired gas. Nitrogen is especially suitable as a gas for the production of opaque quartz glass bodies, which are characterized by a high viscosity and thermally stable hollow spaces H, also called bubbles, and thus by an especially high temperature stability.

In an alternative embodiment, there is no gas filling of the xerogel body, whereby the subsequent compression process is carried out in vacuum, so that vacuoles are formed.

In an eighth process step VS8, the xerogel body is compressed in a sintering process in such a way that the open pores present in the xerogel body collapse. The hollow spaces H in contrast do not collapse. The hollow spaces H shrink but retain their form. Thus, a clear and pure quartz glass forms between the individual hollow spaces H and surrounds these, so that as a result the translucent or opaque quartz glass body Q with gas inclusions, i.e., with gas-filled hollow spaces H, is formed.

The production of a quartz glass body Q will be described below with use of various selected exemplary embodiments. The production of the quartz glass body Q, however, is not limited to the described exemplary embodiments. In particular, the sol S can be generated by using any method. The amounts of displacement bodies added to sol S and the size and form thereof can be predetermined depending on the desired properties of the quartz glass body Q to be generated and not limited to the described sizes.

In a first exemplary embodiment, the sol S is produced according to the example cited in DE 33 90 375 C2 with the use of pyrogenic silicic acid of the type OX50 (Evonik) and then adjusted dropwise to a pH of 4.9 by addition of 0.1 mol/L of ammonia solution. The amount of the titrated sol S is 200 g. The density is 1.10 g/cm³.

Washed PMMA microbeads with a diameter of approximately 10 μm are stirred into the sol S in an amount of 1 g by means of an agitator. Next, the mixture is added to a cylindrical vessel with a 30-mm diameter, in which it is gelled within half an hour.

After an aging phase, the generated wet gel portion is removed and dried in air at a constant room temperature and increased humidity within a week to a xerogel rod with a diameter of 20 mm.

The elimination of the PMMA microbeads from the xerogel occurs in the quartz glass furnace under an oxygen atmosphere with a slow increase in temperature to 500° C.

Next, for purification the xerogel rod is exposed for several hours to a hydrogen chloride atmosphere with a simultaneous increase in the temperature to 800° C. After completion of the purification process, repeated flushing with oxygen is carried out.

The compression of the xerogel occurs finally under a helium atmosphere at 1350° C. within 10 minutes, whereby after cooling an opaque quartz glass rod with a diameter of 15 mm is obtained.

The quartz glass rod is characterized by a homogeneous bubble pattern, i.e., a homogeneous distribution of the hollow spaces H, with a uniform bubble size, i.e., the size of the hollow spaces H, of about 6 μm. The material of the quartz glass rod as well has a high purity with a very low concentration of impurities.

The concentrations of selected elements are given in ppb in Table 1, the density of the material being 2.18 g/cm³.

TABLE 1

| Al | B | Ca | Cu | Fe | K | Li | Na | Ni | Ti | Zr |
|---|---|---|---|---|---|---|---|---|---|---|
| 140 | <30 | <30 | <20 | 20 | <20 | <20 | 50 | <10 | 30 | <10 |

The directed direct transmission of a 1-mm thick and mechanically polished sample within the spectral range of 200 nm to 3200 nm is between 0.2 and 0.4%.

The heating of the sample in the glassblower flame to temperatures as are typical for the welding of quartz glass parts causes a disintegration of the microbubbles and leads to a clear glass.

In a second exemplary embodiment, the compression of the xerogel as a departure from exemplary embodiment 1 is carried out with the same temperature control but under a nitrogen atmosphere. The forming opaque quartz glass rod has a density of 2.18 g/cm³.

Heating of the quartz glass rod to temperatures as are typical for the welding of quartz parts does not lead to any disintegration of the microbubbles. The material remains virtually unchanged and opaque. The filling of the hollow spaces H with nitrogen, which cannot escape from the hollow spaces H and as a result of the arising gas pressure prevents the collapse of the bubbles, is responsible for this.

In a third exemplary embodiment, the sol S is produced from pyrogenic silicic acid of the type HDK D05 (Wacker) and water, which are processed to a 30% dispersion by means of a Conti-TDS-2 disperser (Ystral).

An amount of 200 g of this dispersion is combined with 0.193 g of nitric acid in 60 g water and 97.9 g of tetraethyl orthosilicate and a hydrolysis reaction is caused to occur by stirring. The thus produced component A is cooled to room temperature.

0.68 g of a 25% ammonia solution and 0.6 g of 100% acetic acid are added to a mixture of 1.8 g of PMMA beads with diameters of about 10 μm in 0.53 g of water. The thus prepared component B is mixed homogeneously within 2 minutes with component A and then filled into a glass crystallizing dish.

In the glass crystallizing dish, the sol S gels within a half hour into a disc-shaped gel body with a diameter of 18 cm. After drying of the gel body, its diameter is 12 cm.

Next, the xerogel disc is heated in a furnace, lined with quartz glass, within 8 hours to a temperature of 1350° C. In so doing, a sufficient air exchange in the furnace chamber is assured in the temperature range of 200 to 500° C. After 10 minutes of heating at 1350° C., the disc is slowly cooled to room temperature.

The resulting opaque quartz glass disc has a diameter of 9 cm and appears fully homogeneous upon viewing under an intense light source. The material of the quartz glass disc is characterized by a high purity, whereby no metal exceeds a concentration of 1 ppm.

The production of the quartz glass body Q according to the third exemplary embodiment is characterized by especially low production expenditures and as a consequence especially low production costs.

In a fourth exemplary embodiment, proceeding from the first exemplary embodiment, a titrated sol S is produced in an amount of 600 g. 6.2 g of PMMA beads with diameters of about 6 μm is added to 200 g of this sol S and the mixture is stirred. It is made clear by the fourth exemplary embodiment that a density of the quartz glass body Q to be produced can be specified very precisely.

100 g of the arising mixture is placed in a cylindrical vessel with a 30-mm inside diameter and form a sample 1.

The remaining mixture is diluted with titrated sol S, resulting in amount of 200 g. Of this amount, a portion of 100 g is added to another vessel and forms a sample 2.

The remaining residue is diluted with the remaining amount of the titrated sol S and filled into two other vessels, so that samples 3 and 4 are formed.

The further processes are carried out for all samples as described in the first exemplary embodiment.

The quartz glasses formed from the samples have hollow spaces H with diameters in the range of 2 μm to 3.5 μm and a very high bubble concentration, i.e., number of hollow spaces H.

The measured densities of the samples are listed in Table 2.

TABLE 2

| Sample | Sample 1 | Sample 2 | Sample 3 | Sample 4 |
|---|---|---|---|---|
| Density g/cm³ | 2.103 | 2.146 | 2.171 | 2.170 |

A section of a quartz glass body Q according to the fourth exemplary embodiment is shown in FIG. 2 in a sectional view. The quartz glass body Q has a plurality of hollow spaces H, whose diameters are within the range of 2 μm to 3.5 μm.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the production of a quartz glass body from a gel body, the method comprising:
generating a gel body from a sol in that displacement bodies are added to the sol before a gelling to form the gel body;
completely removing the displacement bodies from the gel body after the gelling, whereby hollow spaces are formed at the positions of the removed displacement bodies;
forming and compressing the gel body into the quartz glass body; and
generating a translucent or opaque quartz glass body, wherein after the removal of the displacement bodies the gel body is compressed such that open pores within the gel body collapse and a dense and clear glass forms between the hollow spaces and surrounds the spaces.

2. The method according to claim 1, wherein the displacement bodies are homogeneously distributed within the sol.

3. The method according to claim 1, wherein a form of the hollow spaces is predetermined by a form of the displacement bodies.

4. The method according to claim 1, wherein the displacement bodies within the gel body are completely burned.

5. The method according to claim 1, wherein the hollow spaces are filled with a gas before the compression of the gel body.

6. The method according to claim 1, wherein the sol is formed from a finely dispersed silicic acid, water, and tetraethyl orthosilicate.

7. The method according to claim 1, wherein spherical displacement bodies are used.

8. The method according to claim 1, wherein displacement bodies are used whose material density is within the range of a material density of the sol.

9. The method according to claim 1, wherein the hollow spaces are made spherical in form.

10. A gel body for the production of a quartz glass body, the gel body comprising:
hollow apertures, the hollow apertures being formed in that displacement bodies are introduced into the gel body and are removed completely from the gel body such that the hollow apertures are formed at the positions of the displacement bodies; and
open pores that collapse during a defined compression such that a dense and clear glass forms between the hollow spaces and surrounds the spaces.

11. A gel body according to claim 10, wherein the displacement bodies are made of plastic, and wherein the plastic is polyethylene, polystyrene, and/or poly-methyl methacrylate.

12. A gel body according to claim 10, wherein the gel body has a porous structure, and wherein the structure is formed such that during the burning of the displacement bodies within the gel body a gas exchange occurs with the surroundings.

13. The gel body according to claim 10, wherein the displacement bodies are made in a substantially spherical form.

14. The gel body according to claim 10, wherein a material density of the displacement bodies is within a range of a material density of the sol.

15. The gel body according to claim 10, wherein the hollow spaces are made in a substantially spherical form.

16. A quartz glass body produced in the method according to claim 1, wherein the quartz glass body has vacuoles or gas-filled hollow spaces, and wherein the hollow spaces have a defined size, are arranged in a defined structure, and a dense and clear glass is formed between the hollow spaces and surrounds the spaces.
